(19) United States
(12) Patent Application Publication
(10) Pub. No.: US 2019/0135684 A1
(43) Pub. Date: May 9, 2019

(54) METHOD FOR DECORATING A HOLLOW GLASS ITEM

(71) Applicant: POCHET DU COURVAL, CLICHY (FR)

(72) Inventor: Romuald GUILBAUT, YAUCOURT BUSSUS (FR)

(73) Assignee: POCHET DU COURVAL, CLICHY (FR)

(21) Appl. No.: 15/770,001

(22) PCT Filed: Oct. 24, 2016
(86) PCT No.: PCT/EP2016/075582

§ 371 Date: Apr. 20, 2018

(30) Foreign Application Priority Data
Oct. 23, 2015 (FR) 15 60138

(51) Int. Cl. C03C 17/00; C03C 17/32; B05B 5/025

(52) U.S. Cl. CPC C03C 17/005; C03C 17/32; C03C 2218/32; C03C 2217/72; C03C 2218/17; B05B 5/025

(57) ABSTRACT

The invention relates to a method for decorating a hollow glass item (3), comprising the following steps:
providing the item and placing it in contact with an electrical ground (21),
spraying electrically charged dyeing powder (27) to produce a deposition (45) of the dyeing powder on a surface (9) of the provided item, the dyeing powder being attracted on the surface by electrostatic forces, and
baking at least the surface of the item including said deposition at a baking temperature.

The invention also relates to a corresponding installation.

### BACKGROUND OF THE INVENTION

### Field of the Invention

The present invention relates to a method for decorating a hollow glass item, for example a vial or a bottle, in particular intended for perfume.

The invention also relates to a corresponding decorating installation.

### Description of Related Art

Many techniques exist for finishing glass, such as screen printing, varnishing, sanding, frosting with acid, for example. These operations are done on the already-blown or formed glass item.

It is further known to perform direct powdering of a surface of a glass item by directly applying a dyeing powder, then optionally firing the deposition thus formed.

Such finishing techniques are generally satisfactory, but one skilled in the art continues to look for new techniques making it possible to obtain a same result faster or more easily, or making it possible to obtain a new treatment allowing a new decorative effect.

Furthermore, it is known to perform electrostatic powdering on certain materials that conduct electricity very well, such as metals.

One aim of the invention is therefore to provide a method for decorating hollow glass item making it possible either to produce an existing decoration more quickly, or to produce a new decoration.

### BRIEF SUMMARY OF THE INVENTION

To that end, the invention relates to a method for decorating a hollow glass item, comprising the following steps:
providing the item and placing the item in contact with an electrical ground,
spraying electrically charged dyeing powder to produce a deposition of the dyeing powder on a surface of the provided item, the dyeing powder being attracted on the surface by electrostatic forces, and
firing at least the surface of the item including said deposition at a firing temperature.

According to particular embodiments, the method comprises one or more of the following features, considered according to any technically possible combinations:
said surface is defined by an outer wall of the item;
the spraying step comprises implementing at least one spray gun for spraying the dyeing powder and including at least one electrode suitable for positively electrifying the dyeing powder;
the dyeing powder comprises at least 50% by weight of an epoxy resin, a polyester, a polyurethane, an acrylic resin or mixtures thereof;
the firing temperature is comprised between 160° C. and 210° C.;
the surface is at a temperature greater than or equal to 100° C. when the deposition is done;
the surface receiving the deposition has previously been varnished;
the placement in contact with the ground is done at least partially by depositing the item on an electrically conducting support connected to said ground; and
the item includes a body defining an open inner volume, the placement in contact with said ground comprising introducing an electrically conductive member into the inner volume, the member being connected to said ground.

The invention also relates to an installation for decorating a hollow glass item, comprising:
a grounding system suitable for being placed in contact with the item,
a system for spraying a dyeing powder to electrically charge the dyeing powder and to deposit the dyeing powder on a surface of the item, the dyeing powder being intended to be attracted on the surface by electrostatic forces, and
a system for firing, at a firing temperature, at least the surface of the item including said deposition.

### BRIEF DESCRIPTION OF THE SEVERAL VIEWS OF THE DRAWINGS

The invention will be better understood upon reading the following description, provided solely as an example, and done in reference to the appended drawings, in which:

FIG. 1 is a schematic illustration of part of an installation according to the invention,

FIG. 2 is a schematic illustration of another part of the installation partially shown in FIG. 1,

FIGS. 3 to 5 are schematic views of alternatives of the grounding system shown in FIG. 1.

### DETAILED DESCRIPTION OF THE INVENTION

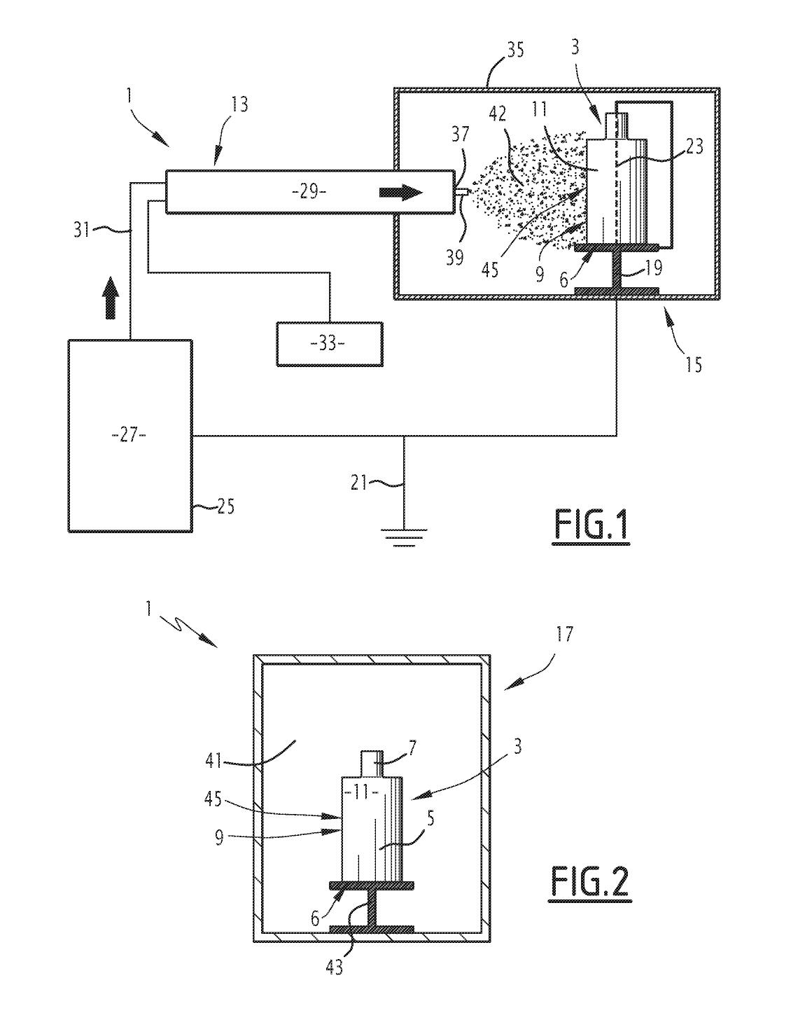

An installation 1 according to the invention is described in reference to FIGS. 1 and 2. The installation 1 is suitable for powdering a hollow glass item 3, for example a bottle or vial intended for perfume.

The item 3 comprises a body 5, a bottom 6 and a ring 7.

The body 5 defines a surface 9 to be decorated, advantageously an outer surface. The body 5 defines an inner volume 11.

The inner volume 11 is outwardly open via the ring 7. The inner volume 11 is for example intended to receive perfume.

The installation 1 comprises a spraying system 13 (FIG. 1), a grounding system 15 suitable for being in electrical contact with the item 3, and a firing system 17 (FIG. 2).

As shown in FIG. 1, the grounding system 15 for example comprises a support 19 provided to support the item 3 and electrically connected to a ground 21. Optionally, the grounding system 15 also includes an electrically conductive member 23 electrically connected to the ground 21.

Ground traditionally refers to a conductive element with zero electrical potential.

The member 23 is suitable for being inserted into the inner volume 11 of the item 3, and placed in electrical contact with the item.

The support 19 is for example suitable for receiving the bottom 6 of the item 3, the item resting upright on the support.

The spraying system 13 comprises a reservoir 25 suitable for containing a dyeing powder 27, a gun 29 for spraying the dyeing powder connected by a hose 31 to the reservoir, and a high-voltage source 33 electrically connected to the gun 29. Optionally, the spraying system 13 also comprises an enclosure 35 suitable for avoiding a dispersion of the sprayed dyeing powder 27. The enclosure 35 is advantageously hermetic, at least during the spraying of the powder.

The dyeing powder 27 for example comprises, at least at 50% by weight, an epoxy resin, a polyester, a polyurethane, an acrylic resin or a mixture of two or more of these compounds. The dyeing powder 27 further advantageously comprises pigments.

The dyeing powder 27 for example includes an anchoring primer.

Alternatively, the anchoring primer is advantageously deposited in advance on the item 3 to allow better anchoring of the powder on the surface 9.

The deposited anchoring primer for example comprises a hydro, UV or epoxy varnish.

The anchoring primer is optional, in particular if the powder is adhesive enough once deposited.

The hose 31 is suitable for allowing the dyeing powder 27 to be conveyed from the reservoir 25 to the gun 29.

The gun 29 comprises an outlet 37 advantageously emerging inside the enclosure 35 to eject the powder, and an electrode 39 suitable for electrifying the dyeing powder 27, for example positively.

The electrode 39 is electrically connected to the high-voltage source 33 to electrify the dyeing powder 27, advantageously by “corona” effect.

As shown in FIG. 2, the firing system 17 is for example made up of a furnace 41 suitable for bringing the surface 9 of the item 3 to a firing temperature.

The furnace 41 for example comprises a support 43 provided to receive the item 3.

According to one particular embodiment (not shown), the enclosure 35 is also a furnace and there is no furnace 41 separate from the enclosure 35. This makes it possible to avoid moving the item 3 between spraying of the dyeing powder and firing.

According to one particular embodiment, the firing system 17 further comprises an infrared tunnel (not shown) in which the item 3 passes to reduce the firing duration of the surface 9.

The operation of the installation 1 will now be described.

The item 3 is first provided at the end of a manufacturing step known in itself. For example, the item 3 is blown in a blow mold (not shown).

The item 3 is placed in contact with the ground 21 by depositing it on the support 19 in the enclosure 35. Optionally, the member 23 is introduced into the inner volume 11.

Then, dyeing powder 27 is sprayed to obtain a deposition 45 of the dyeing powder on the surface 9 of the item 3.

The dyeing powder 27 contained in the reservoir 25 flows through the hose 31 into the gun 29. The gun 29 ejects the dyeing powder 27 through the outlet 37 in order to obtain a cloud of powder 42 near the item 3.

The electrode 39, brought to a very high potential, for example positively electrifies the ejected grains of powder. The ejected dyeing powder 27 is attracted on the surface 9 by electrostatic forces. The deposition 45 forms quickly, advantageously in less than a few seconds.

Next, the item 3 is placed in the oven 41 as shown in FIG. 2. The surface 9 and the deposition 45 are then fired at the firing temperature, advantageously comprised between 160° C. and 210° C.

The firing duration is for example comprised between 6 and 20 minutes.

Advantageously, when the deposition 45 is done as shown in FIG. 1, the surface 9 is at a temperature greater than or equal to 100° C. It has in fact been observed that this improves the quality of the produced decoration in some cases.

According to one particular embodiment, the surface 9 has previously been varnished, by means known in themselves, before the step for spraying the dyeing powder 27.

Owing to the features described above, it is possible to obtain a deposition 45 quickly and easily, having interesting aesthetic qualities.

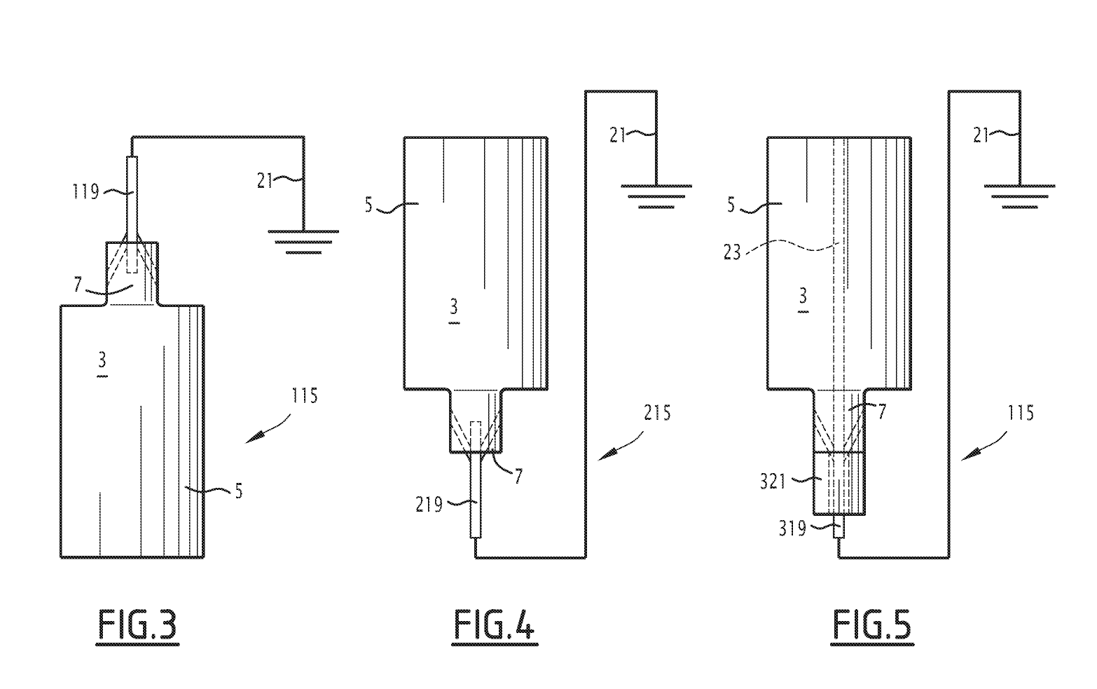

In some cases, depending on how the spraying is done and depending on the configuration of the grounding system 15, the deposition 45 has an appearance that is difficult, or even impossible, to obtain using methods of the prior art. In reference to FIGS. 3 to 5, three grounding systems 115, 215, 315 are described constituting alternatives of the grounding system 15. These alternatives are similar to the grounding system 15. The similar features will not be described again. Only the differences will be described below.

The grounding system 115 shown in FIG. 3 includes a support 119 in electrical contact with the ring 7 of the item 3, the item being fitted on the support.

The support 119 is for example in the form of a rod including a lower tip suitable for grasping the ring 7 of the item 3, for example the inside of the ring.

The grounding system 215 shown in FIG. 4 includes a support 219 in electrical contact with the ring 7 of the item 3, the item being fitted on the support 219.

The support 219 is for example structurally similar to the support 119, except that it includes an upper tip suitable for grasping the ring 7 of the item 3, the ring being oriented downward.

The grounding system 315 shown in FIG. 5 includes a support 319 that is structurally similar to the support 219 and arranged like the support 219 relative to the item 3. The grounding system 315 further includes an electrical insulator 321 situated around the support 319 below, and advantageously in contact with, the ring 7.

The optional member 23 is for example situated in the extension of the supports 119, 219, 319, as shown in FIG. 5.

1. A method for decorating a hollow glass item, comprising the following steps:
providing the item and placing the item in contact with an electrical ground,
spraying electrically charged dyeing powder to produce a deposition of the dyeing powder on a surface of the provided item, the dyeing powder being attracted on the surface by electrostatic forces, and
firing at least the surface of the item including said deposition at a firing temperature.

2. The method according to claim 1, wherein said surface is defined by an outer wall of the item.

3. The method according to claim 1, wherein the spraying step comprises implementing at least one spray gun spraying the dyeing powder the spray gun including at least one electrode suitable for positively electrifying the dyeing powder.

4. The method according to claim 1, wherein the dyeing powder comprises at least 50% by weight of an epoxy resin, a polyester, a polyurethane, an acrylic resin or mixtures thereof.

5. The method according to claim 1, wherein the firing temperature is comprised between 160° C. and 210° C.

6. The method according to claim 1, wherein the surface is at a temperature greater than or equal to 100° C. when the deposition is carried out.

7. The method according to claim 1, wherein the surface receiving the deposition has previously been varnished.

8. The method according to claim 1, wherein placing the item in contact with the ground is done at least partially by depositing the item on an electrically conducting support connected to said ground.

9. The method according to claim 1, wherein the item includes a body defining an open inner volume, placing the item in contact with said ground comprising introducing an electrically conductive member into the inner volume, the member being connected to said ground.

10. An installation for decorating a hollow glass item, comprising:
a grounding system suitable for being placed in contact with the item,
a system for spraying a dyeing powder to electrically charge the dyeing powder and to deposit the dyeing powder on a surface of the item, the dyeing powder being intended to be attracted on the surface by electrostatic forces, and
a system for firing, at a firing temperature, at least the surface of the item including said deposition.
